(19) United States
(12) Patent Application Publication
(10) Pub. No.: US 2022/0164549 A1
(43) Pub. Date: May 26, 2022

(54) NATURAL LANGUAGE PROCESSING PARSIMONIOUS QUESTION GENERATOR

(71) Applicants: AVANEENDRA GUPTA, CUPERTINO, CA (US); ASHOK BARDHAN, EL CERRITO, CA (US)

(72) Inventors: AVANEENDRA GUPTA, CUPERTINO, CA (US); ASHOK BARDHAN, EL CERRITO, CA (US)

(21) Appl. No.: 17/478,091

(22) Filed: Sep. 17, 2021

Related U.S. Application Data
(63) Continuation-in-part of application No. 17/467,139, filed on Sep. 3, 2021.
(60) Provisional application No. 63/074,468, filed on Sep. 3, 2020.

(51) Int. Cl. G06F 40/56; G06F 40/35; H04L 51/02

(52) U.S. Cl. CPC G06F 40/56; H04L 51/02; G06F 40/35

(57) ABSTRACT

A computerized method for natural language generation and managing a parsimonious question generator includes the step of sorting all counties in the United States from a high to low mortality rate by each cause of death for each age group and each gender to generate a set of sorted tables. For a specified subject matter and with a natural language autonomous agent, the method generates a set of parsimonious questions. The set of parsimonious questions are based on a county, an age group, and a gender of an individual designated to answer the set of parsimonious questions. The method sorts the set of parsimonious questions in descending order of importance customized to the individual as described by age, gender, and location. With a natural language generating autonomous agent, the method asks the individual a subset of the set of the parsimonious questions in the optimized order. The method detects that a statistical threshold has been achieved. The method stops the natural language generating autonomous agent from asking further questions in a remainder of the set of parsimonious question when the statistical threshold has been crossed.

### CLAIM OF PRIORITY

This application claims priority to U.S. application Ser. No. 17/467,139, filed on Sep. 3, 2021. This application is incorporated herein by reference in its entirety.

U.S. application Ser. No. 17/467,139 claims priority to U.S. Provisional Application No. 63/074,468, filed on Sep. 3, 2020 and titled METHODS AND SYSTEMS FOR DETERMINING AN OPTIMAL LIFE INSURANCE POLICY ISSUANCE. This provisional application is hereby incorporated by reference in its entirety.

### FIELD OF INVENTION

This invention related to natural language generation by computing systems, and more specifically to a parsimonious question generator in the process of eliciting information from applicants.

### BACKGROUND

It is common that an applicant is required to answer many redundant questions when filing for a service (e.g. life insurance, loan, medical services, etc.). For example, an application for life insurance may require the user to answer scores of questions, sometimes reaching up to a hundred. In addition to personal, physical descriptive data, the questions can involve detailed probing of medical history, hobbies and activities, general lifestyle related questions, as well as questions relating to the illness history of the family and parents and close kin. Usually any answer indicating that the applicant has suffered from some disease in the past usually leads them down entire paths of other auxiliary and supplemental questions, detailing visits to doctors, hospitals, treatment, drugs etc. The overall universe of questions, the order in which they are I asked, the sequencing and disposition is common for most operators in this domain and does not change from applicant to applicant, regardless of their age, gender, health condition or any other factor which could have a salient bearing on the overall health, prospects for longevity and future health trajectory. These questions can often be asked via a computer interface such as a web browser and/or chat bot agent. Accordingly, improvements to the order, types of questions and reduction of questions are desired in order to increase the engagement of the applicant and improve the overall application experience. The PQG is an operational tool in a user journey of the future, saving time and friction, increasing conversion and satisfaction through a customized set of life insurance application journey questions, based on the applicant age, gender and location.

### SUMMARY OF THE INVENTION

A computerized method for natural language generation and managing a parsimonious question generator includes the step of sorting all counties in the United States from a high to low mortality rate by each cause of death for each age group and each gender to generate a set of sorted tables. For a specified subject matter and with a natural language autonomous agent, the method generates a set of parsimonious questions. The set of parsimonious questions are based on a county, an age group, and a gender of an individual designated to answer the set of parsimonious questions. The method sorts the set of parsimonious questions in descending order of importance customized to the individual as described by age, gender, and location. With a natural language generating autonomous agent, the method asks the individual a subset of the set of the parsimonious questions in the optimized order. The method detects that a statistical threshold has been achieved. The method stops the natural language generating autonomous agent from asking further questions in a remainder of the set of parsimonious question when the statistical threshold has been crossed.

### BRIEF DESCRIPTION OF THE DRAWINGS

FIG. 1 illustrates an example system that utilizes an NLP parsimonious question generator to interface with a user/applicant, according to some embodiments.

FIG. 2 illustrates an example process for implementing parsimonious questions, according to some embodiments.

FIG. 3 illustrates an example process for generating a set of parsimonious questions, according to some embodiments.

FIG. 4 illustrates an example process for implementing a parsimonious question generator, according to some embodiments.

FIG. 5 illustrates an example parsimonious question generator system, according to some embodiments.

FIGS. 6 A-C illustrate example screen shots of example parsimonious question generator use cases, according to some embodiments.

FIG. 7 is a block diagram of a sample computing environment that can be utilized to implement various embodiments.

FIGS. 8-10 illustrates a set of example use cases, according to some embodiments.

The Figures described above are a representative set and are not an exhaustive with respect to embodying the invention.

### DESCRIPTION

Disclosed are a system, method, and article of manufacture of a natural language processing parsimonious question generator. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Chatbot can be a software application used to conduct an on-line chat conversation via text or text-to-speech, in lieu of providing direct contact with a live human agent. A chatbot can be run on messaging application(s), text message application (e.g. SMS, etc.), web browser interface, etc.

Confidence interval (CI) is a type of estimate computed from the observed data. This gives a range of values for an unknown parameter (for example, a population mean). The interval has an associated confidence level that gives the probability with which an estimated interval cans contain the true value of the parameter. Goodness of fit of a statistical model describes how well it fits a set of observations. Measures of goodness of fit typically summarize the discrepancy between observed values and the values expected under the model in question. For example, the coefficient of determination, denoted adjusted R² or r² and pronounced “R squared”, is the proportion of the variation in the dependent variable that is predictable from the independent variable(s).

Generative Pre-trained Transformer 3 (GPT-3) is an autoregressive language model that uses deep learning to produce human-like text.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, logistic regression, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Natural-language generation (NLG) is a software process that produces natural language output. NLG can include, inter alia: content determination (e.g. deciding what information to mention in the text); document structuring (e.g. overall organization of the information to convey); aggregation (e.g. merging of similar sentences to improve readability and naturalness); lexical choice (putting words to the concepts); referring expression generation (e.g. creating referring expressions that identify objects and regions); and realization (creating the actual text, which should be correct according to the rules of syntax, morphology, and orthography; etc.

Natural language processing (NLP) is a subfield of linguistics, computer science, information engineering, and artificial intelligence that manages the interactions between computers and natural languages. NLP systems can include, inter alia: speech recognition systems, natural language understanding systems, optical character recognition systems and natural language generation systems. NLP includes methods to analyze large amounts of natural language data. ML systems discussed herein can utilize NLP methods for developing training and verification data sets. ML systems can also use NLP methods to analyze and optimize specified user input.

Principal component analysis (PCA) is the process of computing the principal components and using them to perform a change of basis on the data (e.g. using only the first few principal components and ignoring the rest). A principal components can be a collection of points in a real coordinate space are a sequence of p unit vectors, where the i^{th} vector is the direction of a line that best fits the data while being orthogonal to the first i−1 vectors. A best-fitting line can be defined as one that minimizes the average squared distance from the points to the line. These directions constitute an orthonormal basis in which different individual dimensions of the data are linearly uncorrelated.

Sorting algorithm can be an algorithm that puts elements of a list into an order (e.g. either ascending or descending). In some examples, a machine learning algorithm (e.g. a neural network sorter, etc.) can be utilized.

### Example Systems and Methods

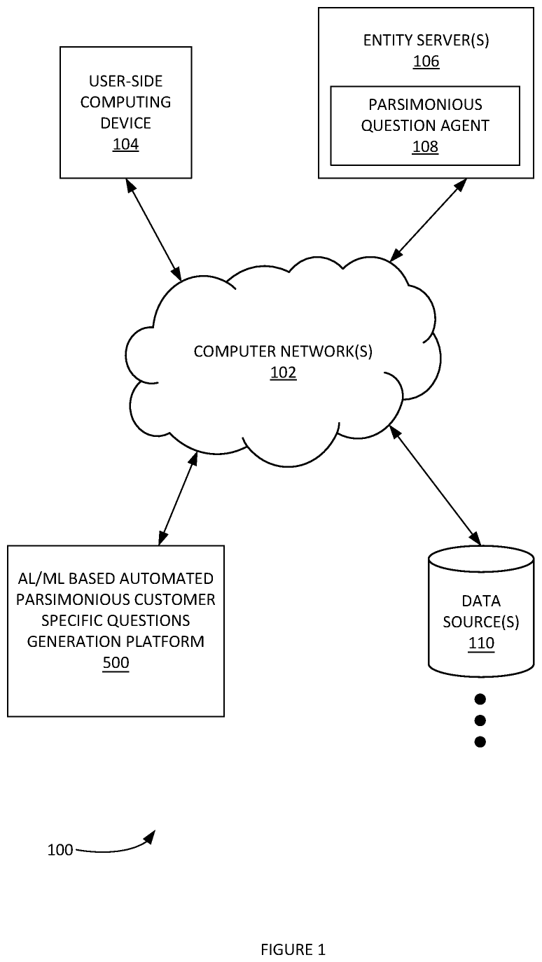

FIG. 1 illustrates an example system 100 that utilizes an NLP parsimonious question generator to interface with a user/applicant, according to some embodiments. System 100 can include AL/ML based automated parsimonious customer and location specific questions generation platform 500. AL/ML based automated parsimonious customer and location specific questions generation platform 500 can be an NLP parsimonious question generator. AL/ML based automated parsimonious customer and location specific questions generation platform 500 can generate parsimonious questions which are specific to the age, gender, and location of a user (e.g. an insurance policy applicant, etc.).

It is noted that there is a vast amount of data, primarily from the Centers for Disease Control, the National Institutes of Health, health.gov etc. which shows that the threat to life expectancy, the mortality rate, the propensity for terminal diseases is a function of, specific to and characterized by age and gender, and frequently also location. This data can be stored in data sources 110. Other publicly available relevant data can also be stored in data sources 110.

It is further noted that the leading causes of death, in short, are specific to age, gender and location, of course in addition to idiosyncratic features relating to genetic make-up of an individual and their personal lifestyle choices of nutrition and exercise. In one example embodiment, a user can use using side computing system 104 to access a life insurance application with entity server(s) 106 (e.g. can be an insurance company server system, etc.). Entity server(s) 106 can interface with the user/applicant via parsimonious question agent 108. Entity server(s) 106 can use parsimonious question agent 108 to obtain data used to determine an overall prospects for life expectancy, the probability of mortality at each age into the future, the questions are an important revelatory process, etc. Parsimonious question agent 108 can include one or more chatbot functionalities and systems. Parsimonious question agent 108 can obtain questions from AL/ML based automated parsimonious customer and location specific questions generation platform 500. AL/ML based automated parsimonious customer and location specific questions generation platform 500 can also obtain relevant information (e.g. age, gender, location, etc.) from parsimonious question agent 108 in order to generate and rank a list of parsimonious questions.

Many of the questions are vital to an important revelatory, discovery process in assessing future prospects for life and health trajectory. However, quite a few are redundant, unnecessary, and superfluous. One example use case can include 25- to 35-year-old applicants where, going by data, all the leading causes of death are not natural, accordingly can be a waste of time on the part of the application to wade through scores and scores of irrelevant detailed disease related questions. The latter can be substituted by many higher-level compulsory questions. In the life insurance underwriting example, these mandatory questions can be about smoking, parental cancer incidents, etc. Parsimonious question agent 108 can manage the dialog session. Parsimonious question agent 108 can ask a set of relevant questions in a sequence based on a given gender, age, and location of the user/applicant.

Data sources 106 can include any databases of, inter alia: Centers for Disease Control, National Center for Health Statistics, the National Institutes of Health, the American Medical Association, American Hospital Association, Bureau of Labor Statistics, to demographic sources, such as the US Census, the American Community Survey, the American Time Use Survey, County Health Rankings, etc. It is noted that AL/ML based automated parsimonious customer and location specific questions generation platform 500 include web scrappers, database managers, data mining systems, web bots, etc. for obtaining and/or otherwise accessing data sources 106. Computer networks 102 can include the Internet, enterprise networks, etc. and enables the entities of FIG. 1 to digitally communicate. It is noted that the NLP parsimonious question generator discussed herein can be applied to other verticals in addition to the insurance examples and use cases discussed herein by way of example and not of limitation.

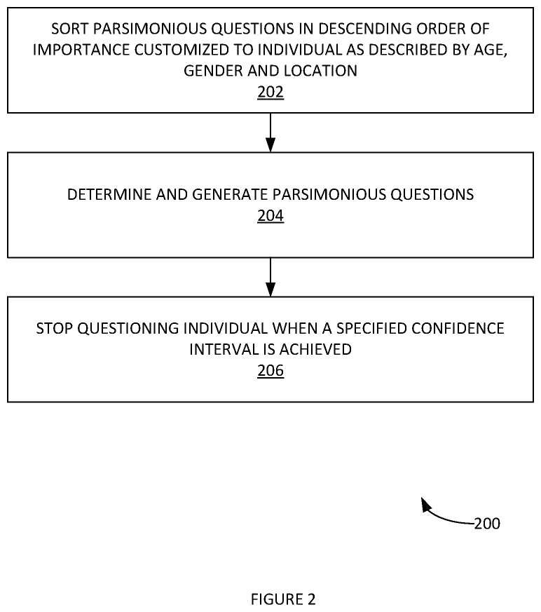

FIG. 2 illustrates an example process 200 for implementing parsimonious questions, according to some embodiments.

In step 202, process 200 can sort parsimonious questions in descending order of importance customized to individual as described by age, gender, and location. In this way, the parsimoniously generated questions are asked in a descending order of potential contribution to future cause of death, mortality rate, terminal illness etc. Specified machine learning algorithms can be used to optimize the sorting of data tables, questions, etc. For example, a question sorting model can be generated with a training data set. The question sorting model can be verified and optimized with a validation data set. In a life insurance example, the question sorting model can then be used to sort questions for a user's age, county location and gender such that the maximum percent of causes of death (and/or other goal of the questions such as loan default calculation, career/education goals optimization, etc.) can be obtained in the fewest questions possible.

In step 204, process 200 can determine and generate parsimonious questions. For example, process 200 can generate the questions that account for most of either of cause of death, risk attitude and/or any metric that pertains to lifestyle, behavioral aspect that has a bearing on life expectancy are important, etc. In one example, the questions can be drawn from the location/county, age and gender specific leading causes of death, mortality, and terminal illnesses, sorted from high to low by step 204 supra. For example, given five age brackets, two genders and 3000 plus counties there are over 30000 tables to be analyzed and utilized with a descending order of causes of death from high to low, as a share of overall deaths. The leading causes of death will be summed across the age groups over which the life insurance term is valid (e.g. if a 30-year-old is applying for 15-year term policy, then the leading causes of death for ages 30 to 45 will be summed up). The order of questions will therefore be determined, for each county, age group and gender by the descending order of leading causes of death.

In step 206, process 200 stops asking questions when a certain statistical threshold has been crossed. This threshold is determined by the overall sum of deaths by leading causes as a share of overall deaths for that cohort, gender and location crossing a benchmark. The threshold can be adjustable in both a heuristic and a computational sense. Parsimonious question agent 108 can determine the threshold.

Accordingly, process 200 can asks the important relevant questions; in descending order of importance customized to individual as described by age, gender, and location; and stops asking when with reasonable confidence we can gauge the future prospects for life expectancy. The output of process 200 can be provided to parsimonious question agent 108 of system 100. Parsimonious question agent 108 can be instructed to stop asking questions when the threshold is reached. AL/ML based automated parsimonious customer and location specific questions generation platform 500 can implement process 200.

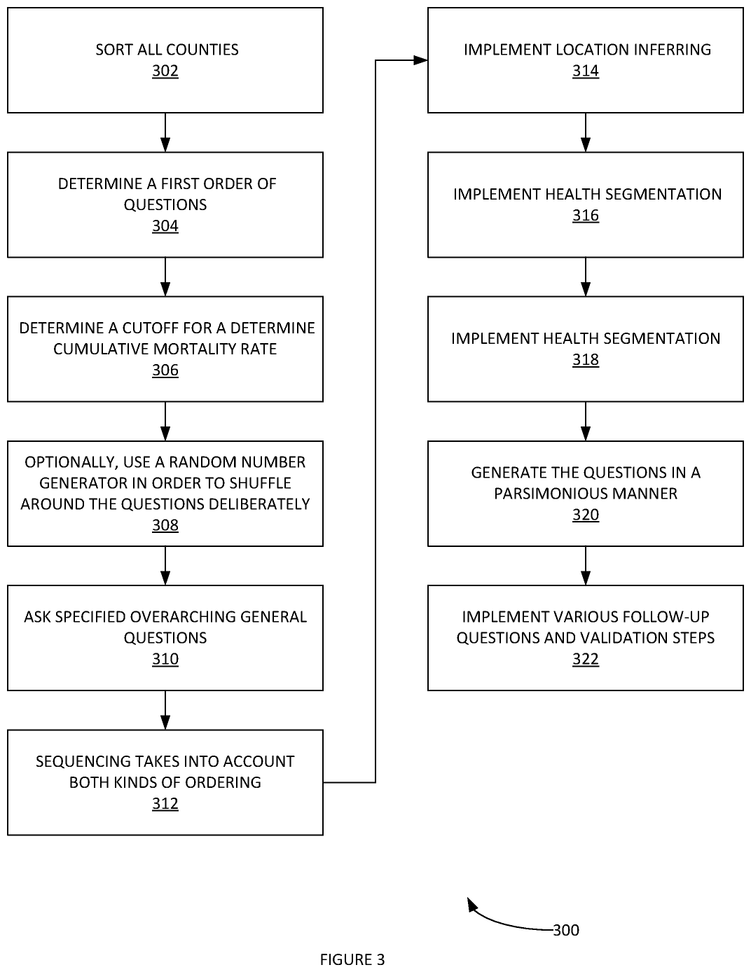

FIG. 3 illustrates an example process 300 for generating a set of parsimonious questions, according to some embodiments. In step 302, process 300 can sort all counties (and/or other appropriate geographic region) in the United States (and/or other political entity). The sorting can be by high to low mortality rate; by cause of death for each age group and gender; etc. This can create over 30,000 sorted tables.

In step 304, process 300 can determine a first order of questions. The can be based on the persona. Process 300 can use an NLG question generating engine to generate corresponding questions. For example, if the leading cause of death for that age group/gender in that county is auto fatalities, then NLG engine can first generate a question on driving violations, etc. If a cause of death is suicide, NLG engine can then generate a question on treatment for depression or drug behavior etc.

In step 306, process 300 can determine a cutoff for a cumulative mortality rate For example, a cutoff rule can be as follows: when the statistical power of questions/answers reaches 90% of the share of deaths in total deaths over the term of the policy (e.g. the summation of age group mortality from 25 to 45, if it's a 25-year-old with 20-year policy, etc.) or the top twenty causes of death, whichever comes first. It is noted that the cutoff rule can be adjusted based on feedback learning methods and the like.

Optionally, in step 308, process 300 can use a random number generator in order to shuffle around the questions deliberately. In step 310, process 300 can determine a cutoff of the overall number of questions. An exception to this can be when process 300 is also including location inferring (e.g. as this can be used to reduce the number of questions further). It is to be noted that the overall methodology involves generating a) which questions, b) in what order, and c) when to stop asking. The order of questions, however, can be both randomized to a degree, based on auxiliary variables.

It is noted that some health-related questions, even though they may play a relatively small part in the share of deaths in a particular cohort at the particular location may still need to be asked. This can be due to the fact that mortality rate consists of two ratios: how many people are affected (e.g. cancer and the incidence of cancer) and what is the survival rate (e.g. deaths/population=(deaths/incidence)*(incidence/population). Therefore, the first ratio can be the weight or importance or lethality, and the second ratio is how widespread it is. If both ratios are small, process 300 may not need ask the specified question. Accordingly, in step 312, the sequencing can take into account both kinds of ordering, high incidence, high mortality rates overall and low survival rates or the death/incidence ratio.

In step 314, specified overarching general questions can be asked. These can also be a proxy for a number of other questions for which direct answers are difficult to obtain. For example, proxy questions can be asked for, inter alia: body mass index (BMI) (e.g. through questions about height and weight). A BMI calculation can lead to a follow up questions about for example CPAP, diabetes, etc. It is noted that BMI can be a key causal factor for various pathologies. Other proxy questions can be about food habits, exercise habits and the like. Indirect, proxy questions can be asked to assess risk appetite (e.g. for example online Internet usage, indicating that anyone who spends a lot of time on the Internet is not really stepping out into the real world, etc.). Another proxy question can be how often the user eats and/or cooks at home. Data and modeling on American Time Use Surveys can also serve as auxiliary tools.

In step 316, process 300 can implement location inferring. A location measure and index reflecting prospects for health and life can be a proxy metric as a county-level score can be a proxy variable for filling void for range of questions. Various location inferring methods can be utilized (e.g. principal component analysis (PCA) of relevant key factors; residual analysis model for which counties are outliers and have higher mortality than predicted by a model; etc.). Process 300 can also utilize other proxies/externalities. For example, population density may be a factor in accidents and accident mortality rate.

In step 318, process 300 can implement health segmentation. As provided herein, health segmentation can determine with a specified degree of statistical confidence an association between a user with a proprietary county-based user health segments. Each county can have top 3 or 4 common health/life profiles. For example, it can be determined if the user elderly, active and well-off or the laid-back, middle-aged, cook-at-home new-agers, etc. It is noted that segments can be developed as PCA-Index based on county data.

In step 320, process 300 can generate the questions in a parsimonious manner. The variation in the phraseology of the questions can be achieved through GPT3 and/or various other NLP/NLG processes.

In step 322, process 300 can implement various follow-up questions and validation steps. In addition to the answers to specific questions entering the model, process 300 can provide augmented by location and generate one or more follow up questions. Process 300 can also implement needed backend calculations leading to questions, as well as checking for internal consistency of logic. These can be related to, inter alia: age validation, BMI validation (e.g. using anomaly detection), health status validation, etc. AL/ML based automated parsimonious customer and location specific questions generation platform 500 can implement process 300.

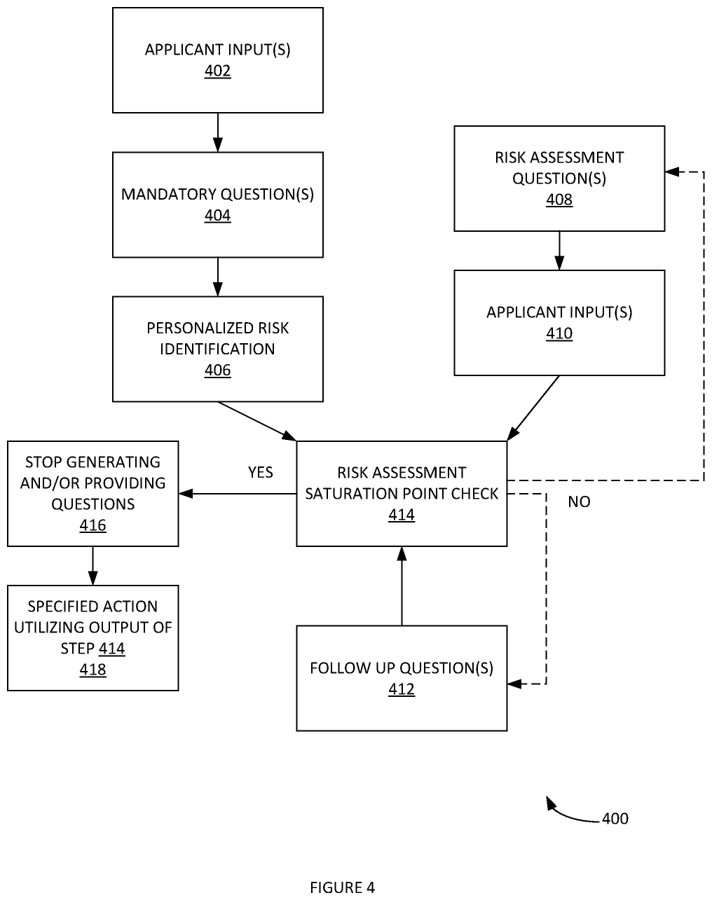

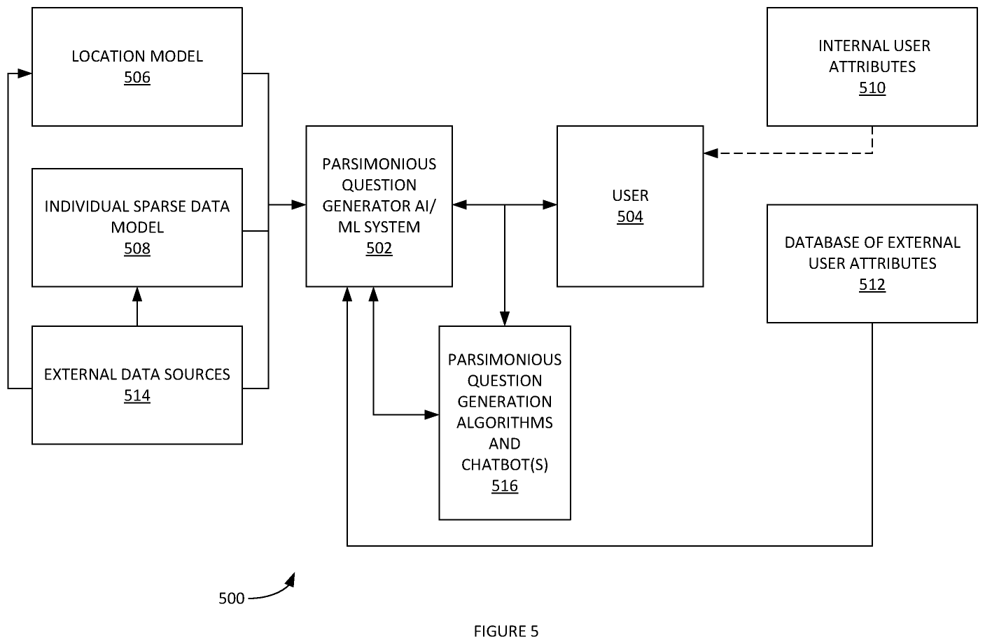

FIG. 4 illustrates an example process 400 for implementing a parsimonious question generator, according to some embodiments. Obtain applicant inputs in step 402. Generate and ask mandatory questions in step 404. These can be related to the specific vertical and/or subject matter to which process 400 is being applied. These can also be ‘knock out’ questions regarding ineligibility for the goal of the questions (e.g. ineligibility for life insurance, loan, etc.). In step 406, process 400 can determine a personalized risk identification. This can be determined from the user's answers to the questions (e.g. the sorted descending order of importance questions regarding leading causes of death by gender, age and location discussed supra). This information can be passed to step 414. Step 414 can implement a risk assessment saturation point check.

If this answer is ‘no’, process 400 can proceed to step 408 or step 412 depending on the state of step 400. In step 408, process 400 can ask specified risk assessment question(s). In step 410, process 400 can obtain applicant inputs. This information can be passed to step 414. In step 412, process 400 can determine and ask relevant follow up questions. This information can be passed to step 414.

If in step 414, it is determined that the answer is yes (e.g. The saturation point check determines that the threshold has been reached), then process 400 proceeds to step 416. In step 416, process 400 can stop generating and/or providing questions. It is noted that the outputs of steps 406 and 412 can be used to update the output of step 406 and a personalized risk identification determined. In step 418, process 400 can output the personalized risk identification. This can be to determine an insurance underwriting, insurance quote, etc. AL/ML based automated parsimonious customer and location specific questions generation platform 500 can implement process 400.

FIG. 5 illustrates an example parsimonious question generator system 500, according to some embodiments. System 500 can include parsimonious question generator Al/ML system 502. Parsimonious question generator Al/ML system 502 can use a chat bot (and/or similar autonomous NLP/NLG agent system) to interface with user 504. Parsimonious question generator Al/ML system 502 can have a goal of obtaining a set of data that sufficiently represents totality of individual information 510 (e.g. in insurance underwriting case can be, inter alia: individual genetics, nutrition, lifestyle, external, social factors that determine health and life expectancy, etc.) for user 504. In a life insurance example, this can be reaching a threshold of a specified share of deaths accounted for in the applicant's cohort (e.g. based on age, county, and gender, etc.). This can be eighty percent of accounted for deaths, ninety percent of accounted for deaths, etc. In a loan eligibility example, this can be a probability threshold for percent of loan defaults etc. Once the threshold is reached, the questioning by the chatbot agent can stop. For example, if just three questions account for ninety percent of causes of death, loan default, etc. for the next years, then there may not be a need to ask additional questions (e.g. other than mandatory questions discussed supra, etc.).

Parsimonious question generator Al/ML system 502 can use a user's age, gender, and location to ask questions of the user 504 to efficiently obtain sufficient information about the internal user attributes 512 in a parsimonious manner. In this way, the user need only answer a few questions rather than 20-100 questions. User 504 can interface with Parsimonious question generator Al/ML system 502 via parsimonious question generation algorithms and chatbot(s) 516 (e.g. a chatbot, etc.). Parsimonious question generator Al/ML system 502 can utilize database of external user attributes 512, location model 506, individual sparse data model 508 (e.g. age and gender model) and/or external data sources 514 to generate and sort the questions for user 504. These data models can be included 30,000 tables by county, age, and gender. Sorting, PCA, other ML models can be applied to these tables. The causes of death for these tables are pre-sorted by highest to lowest causes of death and NLP/NLG algorithms can generate questions related to the highest causes of deaths for the age, gender, and location tables applicable to user 504. Parsimonious question generator Al/ML system 502 can have an interactive aspect such that the answer to a question can enable the dynamic selection of a next question (e.g. in a heuristic manner).

If a leading cause of death does not change over a significant period for a specified age, gender, and location combination then a lower threshold can be used by parsimonious question generator Al/ML system 502. However, parsimonious question generator Al/ML system 502 can increase the threshold value when it detects increased temporal variation of the cause of death for a specified age, gender, and location combination. In this, threshold values can be dynamically updated based on detected changes (in terms of both causes and orders of causes, etc.) to age, gender, and location combinations.

Parsimonious question generator Al/ML system 502 can use algorithms that target as few questions as possible. These questions can obtain data that is a proxy for the idiosyncratic mode of the user's genetic make up and overall lifestyle. This is because age and gender control for the most variance of life expectancy (e.g. in the life insurance example). User location (e.g. on a county basis) also accounts for a large component of the variance in determining life expectancy. With these variables, 80-90% of the causes of death in specified age cohorts can be determined.

It is noted that this can include an NLP/NLG system (not shown) for generating questions. The NLP/NLG system can vary phraseology of questions to increase engagement of applicant. The NLP/NLG system can adjust vocabulary, syntax and phraseology based on common vocabulary for the applicant's age and county dialect for example. In this way, the NLP/NLG system can also increase applicant engagement. The NLP/NLG system can obtain age/location from publicly available linguistics databases. The NLP/NLG system can dynamically vary vocabulary and phraseology between different applicants and different sessions.

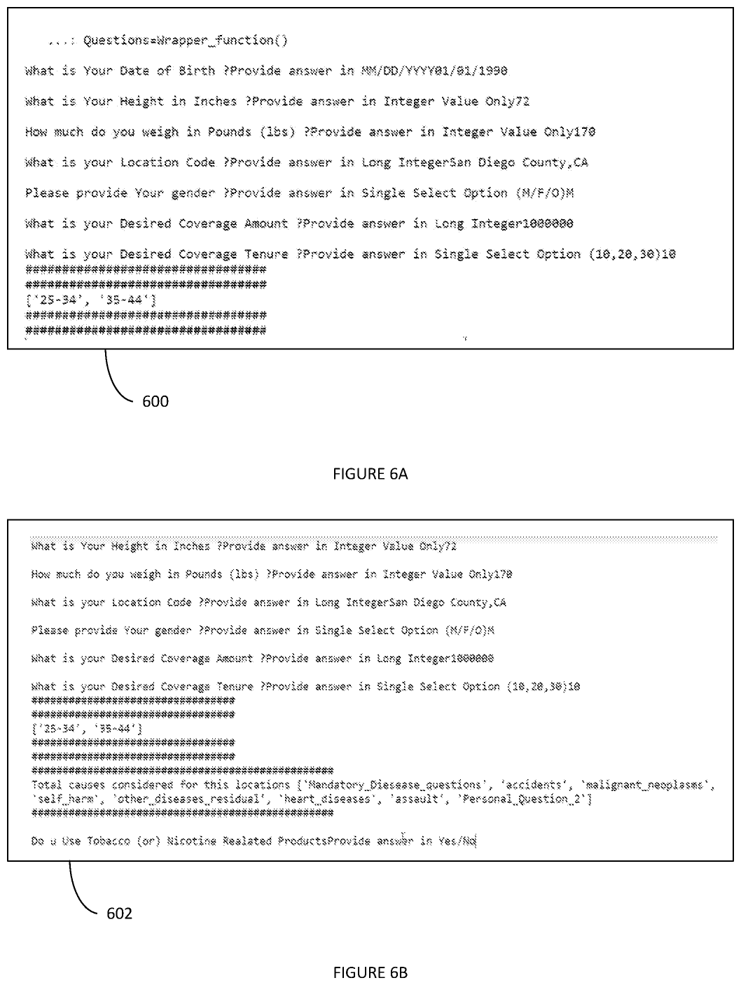

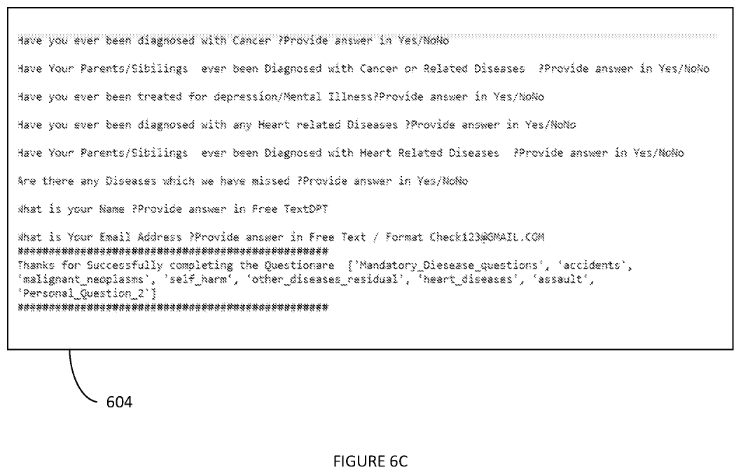

FIGS. 6 A-C illustrate example screen shots 600-604 of example parsimonious question generator use cases, according to some embodiments. Screen shot 600 shows a set of initial questions. Screen shot 602 shows key leading causes of death for this location, gender, age, etc. A quick complete operation is shown in screen shot 604.

Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Additional Example Computer Architecture and Systems

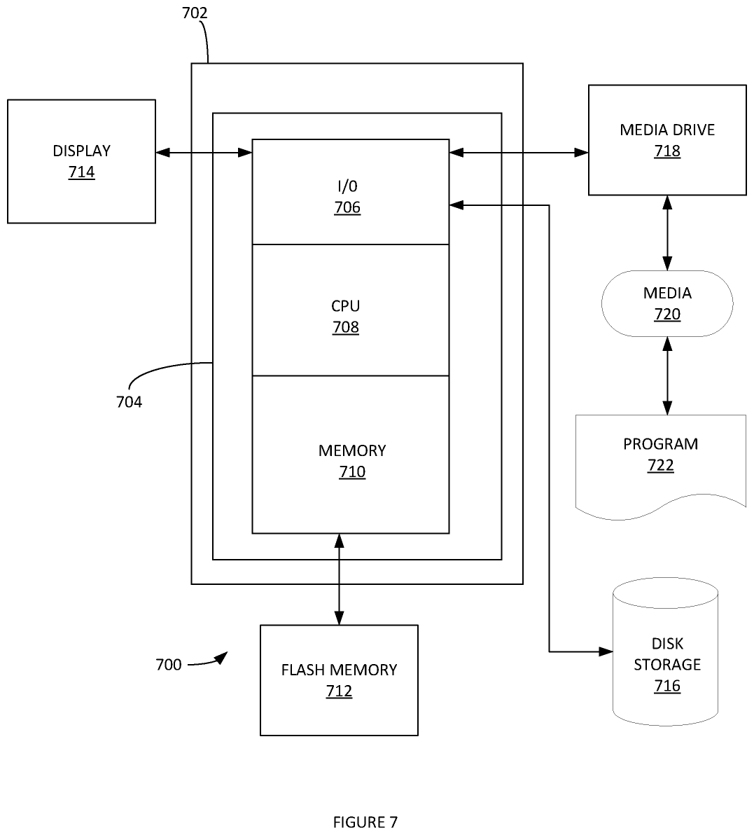

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Example Use Cases

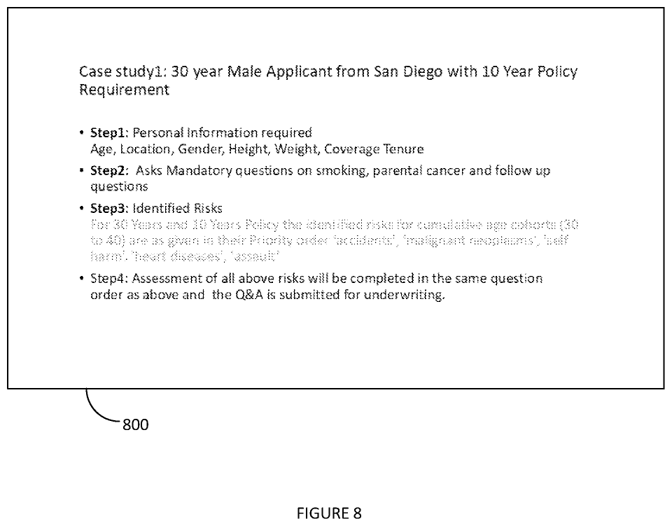

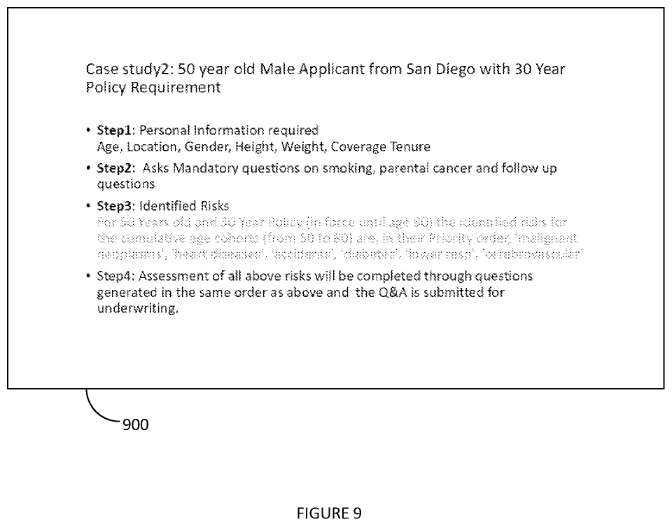

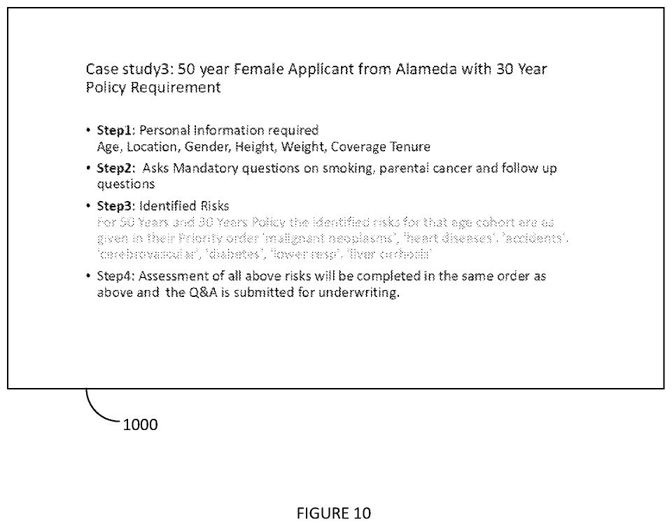

FIGS. 8-10 illustrates a set of example screen shots of use cases 800-1000, according to some embodiments. These example use cases related to a life insurance examples. These examples can be modified for other types of services/goals such a loans, educational goals, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for natural language generation and managing a parsimonious question generator comprising:
sorting all counties in the United States from a high to low mortality rate by each cause of death for each age group and each gender to generate a set of sorted tables;
for a specified subject matter and with a natural language autonomous agent:
generating a set of parsimonious questions, wherein the set of parsimonious questions are based on a county, an age group, and a gender of an individual designated to answer the set of parsimonious questions;
sorting the set of parsimonious questions in descending order of importance customized to the individual as described by age, gender, and location;
with a natural language generating autonomous agent, asking the individual a subset of the set of the parsimonious questions in the optimized order;
detecting that a statistical threshold has been achieved; and
stopping natural language generating autonomous agent from asking further questions in a remainder of the set of parsimonious question when the statistical threshold has been crossed.

2. The computerized method of claim 1, wherein the set of parsimoniously generated questions are asked via a chat bot functionality in a descending order of a potential contribution to future cause of death.

3. The computerized method of claim 1 further comprising:
using a machine learning algorithm to optimize the sorting of the set of sorted tables.

4. The computerized method of claim 3, wherein the machine learning algorithm comprises a sorting algorithm.

5. The computerized method of claim 4, wherein the machine learning algorithm generates question sorting model with a training data set comprising a first historical set of county mortality data for each age group and each gender.

6. The computerized method of claim 5, wherein the machine learning algorithm uses a second historical set of county mortality data for each age group and each gender to validate the question sorting model.

7. The computerized method of claim 6 further comprising:
using the question sorting mode to sort questions for based on a county, an age group, and a gender of an individual designated to answer the set of parsimonious questions to maximize a maximum percent of causes of death that are obtained in a fewest number of questions.

8. The computerized method of claim 7, wherein the natural language autonomous agent varies a phraseology of the parsimonious set of questions to increase an engagement of the individual designated to answer the set of parsimonious questions.

9. The computerized method of claim 7, wherein the natural language autonomous agent adjusts a vocabulary, and a syntax of the set of parsimonious questions based on a common vocabulary for an age of the individual and a county dialect of a county where the individual lives.

10. The computerized method of 7, wherein the natural language autonomous agent obtains the mortality rate by each cause of death for each age group and each gender for each county in the United States from a plurality of publicly available databases.

11. A computerized system comprising:
a processor configured to execute instructions;
a memory containing instructions when executed on the processor, causes the processor to perform operations that:
sort all counties in the United States from a high to low mortality rate by each cause of death for each age group and each gender to generate a set of sorted tables;
for a specified subject matter and with a natural language autonomous agent:
generate a set of parsimonious questions, wherein the set of parsimonious questions are based on a county, an age group, and a gender of an individual designated to answer the set of parsimonious questions;
sort the set of parsimonious questions in descending order of importance customized to the individual as described by age, gender, and location;
with a natural language generating autonomous agent, ask the individual a subset of the set of the parsimonious questions in the optimized order;
detect that a statistical threshold has been achieved; and
stop natural language generating autonomous agent from asking further questions in a remainder of the set of parsimonious question when the statistical threshold has been crossed.

12. The computerized system of claim 11, wherein the set of parsimoniously generated questions are asked via a chat bot functionality in a descending order of a potential contribution to future cause of death.

13. The computerized system of claim 11, wherein the memory contains instructions that when executed on the processor, causes the processor to perform operations that:
use a machine learning algorithm to optimize the sorting of the set of sorted tables.

14. The computerized system of claim 13, wherein the machine learning algorithm comprises a sorting algorithm.

15. The computerized system of claim 14, wherein the machine learning algorithm generates question sorting model with a training data set comprising a first historical set of county mortality data for each age group and each gender.

16. The computerized system of claim 15, wherein the machine learning algorithm uses a second historical set of county mortality data for each age group and each gender to validate the question sorting model.

17. The computerized system of claim 16, wherein the memory contains instructions that when executed on the processor, causes the processor to perform operations that:
uses the question sorting mode to sort questions for based on a county, an age group, and a gender of an individual designated to answer the set of parsimonious questions to maximize a maximum percent of causes of death that are obtained in a fewest number of questions.

18. The computerized system of claim 17, wherein the natural language autonomous agent varies a phraseology of the parsimonious set of questions to increase an engagement of the individual designated to answer the set of parsimonious questions.

19. The computerized system of 18, wherein the natural language autonomous agent obtains the mortality rate by each cause of death for each age group and each gender for each county in the United States from a plurality of publicly available databases.

20. The computer system of claim 19, wherein a statistical threshold is generated based on historic volatility, goodness of fit of models and variable nature of the top causes of death historically.
